(19) United States
(12) Patent Application Publication
(10) Pub. No.: US 2006/0251553 A1
(43) Pub. Date: Nov. 9, 2006

(54) Microfluidic device for carrying out a reaction

(75) Inventors: Ventzeslav Iordanov, Delft (NL); Pasqualina Maria Sarro, Delft (NL); Adrianus Bossche, Capelle Aan Den Ijssel (NL); Jeroen Bastemeijer, Spijkenisse (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 11/408,698

(22) Filed: Apr. 20, 2006

Related U.S. Application Data
(63) Continuation-in-part of application No. PCT/NL04/00618, filed on Sep. 7, 2004.

(30) Foreign Application Priority Data
Oct. 21, 2003 (NL) 1024578

(51) Int. Cl. B01J 8/04; B01J 10/00

(52) U.S. Cl. 422/191; 422/188; 422/198

(57) ABSTRACT

A device for carrying out a reaction, which device comprises a wafer provided with a group of at least two wells. The wells are thermally separate from each other by means of a groove in a layer of the device, while parts separated by the groove are locally connected by bridges. In this way a device is provided combining great mechanical strength with good thermal insulation.

### CROSS-REFERENCE TO RELATED APPLICATIONS

This application is a continuation-in-part application of International Patent Cooperation Treaty (PCT) Application Serial No. PCT/NL2004/000618, entitled “MICROFLUIDIC DEVICE FOR CARRYING OUT A REACTION”, filed on Sep. 7, 2004, and the specification and claims thereof are incorporated herein by reference.

This application claims priority to and the benefit of the filing of Netherlands Patent Application Serial No. 1024578, entitled “MICROFLUIDIC DEVICE FOR CARRYING OUT A REACTION”, filed on Oct. 21, 2003, and the specification and claims thereof are incorporated herein by reference.

### BRIEF SUMMARY OF THE INVENTION

The present invention relates to a device for carrying out a reaction, which device comprises a wafer provided with a group of at least two wells.

Such device is known in the art, for example, for carrying out biochemical reactions.

An important aspect of devices manufactured by integrated circuit technology is that, in order to use them in practice, they have to be able to withstand the practical conditions (such as mechanical and temperature stress). In other words, the device has to be embodied so as to be sufficiently strong. However, with respect to devices subject to temperature stress, this must detract as little as possible from the necessary thermal insulation so as not to, or at least as little as possible, affect neighboring wells.

The object of the present invention is to provide a device combining great mechanical strength with good thermal insulation.

To this end, the invention provides a device of the kind mentioned in the preamble, which is characterized in that the wells are thermally separate from each other and the device further comprises means for altering the temperature of the wells, wherein the wafer comprises at least two layers of which a first, top layer forms the bottom of a well, and the thermal separation is provided by at least one recess in a second layer located under the first layer, such that

there is at least one recess between two adjacent wells,

the second layer when projected on the first layer, will at the bottom of a well cover at least part of the bottom, which portion of the second layer that when projected covers at least part of the bottom, is termed mechanically reinforcing portion, and the second layer is connected by means of at least one bridge with a portion of the second layer located outside of the projected portion of the bottom of the well on the second layer, which portion of the second layer, the projection of which is located outside the bottom, is termed bulk portion, and the means for altering the temperature of the wells are, when projected on the first layer, located at the bottom of a well.

The recess or recesses provide an excellent thermal insulation while on the other hand, the mechanically strengthening part reinforces the bottom and the at least one bridge guarantees a reinforcing connection with the second layer. The at least one bridge may or may not be in contact with the first layer. The means for altering the temperature comprise, for example, a Peltier element. When in the present invention reference is made to a first layer and a second layer, this does not preclude the possibility of one or both being composed of several sublayers. For example, the first layer may comprise a first sublayer encompassing the means for electrically altering the temperature, a second sublayer electrically insulating the first sublayer, an electricity-conducting third sublayer partly penetrating the second sublayer to make contact with the first sublayer in order to supply the first sublayer with electricity. A fourth sublayer applied over the third sublayer and providing electrical insulation as opposed to an electrically conducting fifth sublayer also being in contact with the first sublayer but not with the third electricity-conducting sublayer, as well as an electrically insulating sixth sublayer forming the actual bottom of the well.

In the present application, a well is understood to be a place on the device, which is surrounded by a standing wall but also, in the absence of such a wall, by the place where the means are provided for altering the temperature. The device according to the invention may comprise one or several integrated sensors, preferably located at one, in particular at each well. It may be favorable for the layer comprising connections for transducers (means for altering the temperature, sensors, etc.) to the second, bottom layer, since in this way a more defined, for example, a smoother top side of the first layer can be obtained. This is useful for conducting assays. The recesses may have the form of a row of openings that do not go through completely, wherein not going through relates to the total thickness of the device.

Kersjes R. et al. (Sensors and Actuators A, 46-47, pp. 373-379 (1995)) describe a flow sensor wherein a thermal insulation is provided by means of oxide-filled grooves. On the one hand, the use of filled grooves increases the mechanical strength, with varying temperatures on the other hand, it increases the mechanical stress in the device. In addition, it limits the degree of insulation.

According to a favorable embodiment, the recess is formed like a groove.

Such a recess provides an excellent thermal insulation over a considerable distance. Furthermore, it is easy to realize using standard (Integrated Circuit) IC-fabrication techniques.

A preferred embodiment is characterized in that the mechanically strengthening part located under a well is connected with the bulk portion via at least 3 bridges distributed over the circumference of the strengthening part. In this way an outstanding mechanical strength can be achieved.

Advantageously, the means for altering the temperature of the wells is integrated in the second layer.

According to an important embodiment, the means for altering the temperature are means for heating the well.

For example, heating may locally start a chemical reaction, whereas this does not occur on neighboring locations on the device. Such a reaction may, for example, be used for the synthesis of oligopeptides or oligonucleotides in the wells. Another important possibility is the use of the device for polynucleotide amplification, such as a Polymerase Chain Reaction (PCR).

Advantageously at least the first layer is an optically transparent layer.

It is then possible to carry out an optical measurement in the well while the detector and/or the optional excitation source do not need to be positioned at the side of the well. For example, the excitation may occur through the first layer.

The invention also relates to a method of manufacturing a device in accordance with the invention. This is characterized in that

a wafer, which will form a second layer, is provided with a first, top layer,

at the bottom side in the second layer, the wafer is provided with a recess between two adjacent wells in the first layer.

Finally, as important application of the device according to the invention, the invention relates to a method of carrying out a polynucleotide amplification. This is characterized in that a device according to the invention is used, wherein the temperature is varied cyclically.

The device according to the invention is very convenient since it comprises little thermal mass and affords good thermal insulation, so that the polynucleotide amplification cycle can be completed quickly (little loss of time caused by heating/cooling). Cooling may take place passively.

### DESCRIPTION OF THE DRAWINGS

The present invention will now be elucidated by way of an exemplary embodiment and the drawing, in which

FIG. 1 shows a top view of a device according to the invention, comprising four wells;

FIG. 2 shows a perspective top view of a part of the device depicted in FIG. 1;

FIG. 3 shows a perspective bottom view of a part of the device depicted in FIG. 1;

FIG. 4 shows a cross section along the line IV-IV of the device depicted in FIG. 1; and

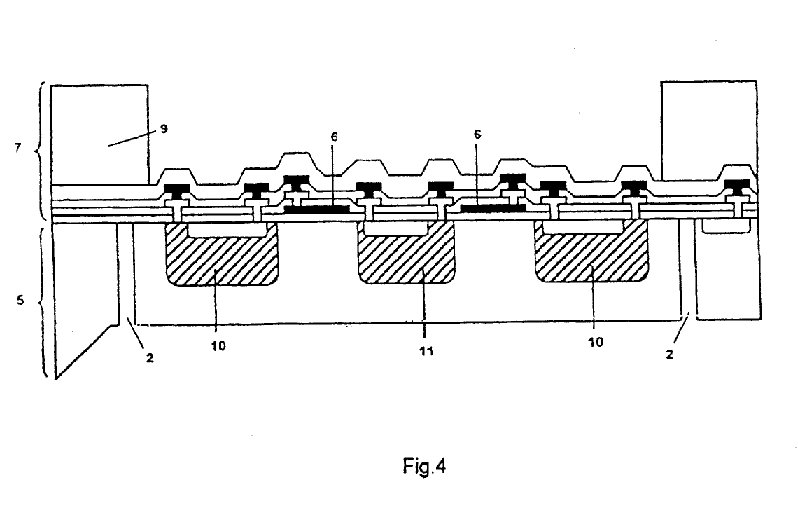

FIG. 5 shows a graph of a temperature cycle carried out with the device according to the invention.

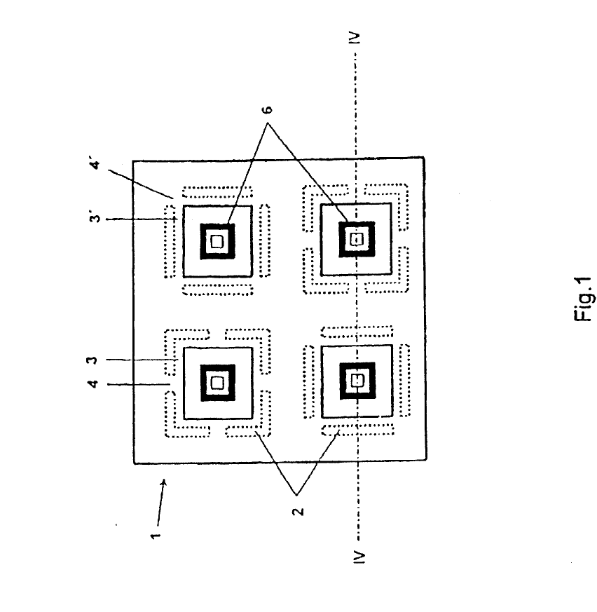

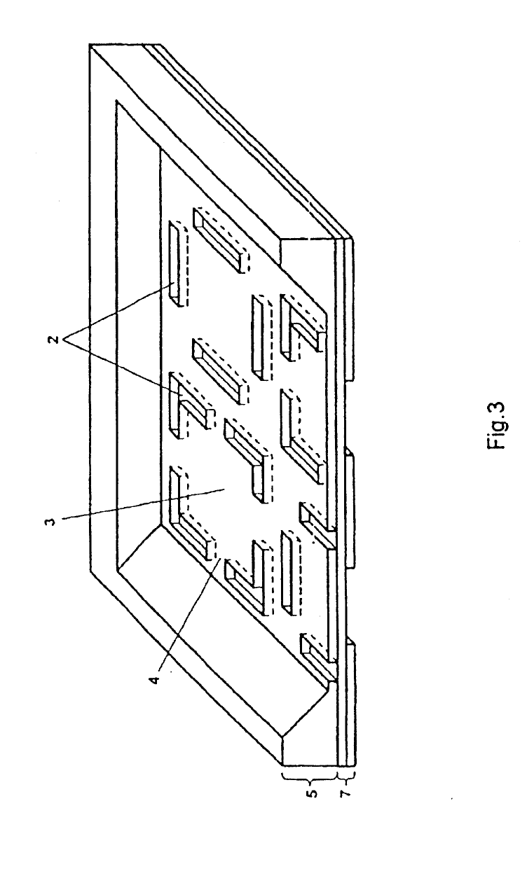

FIG. 1 shows a top view of a device 1 according to the invention, fabricated in accordance with Integrated Circuit (IC) techniques. Grooves 2 bounding an island 3 are indicated at the bottom side of the device. The device shown here comprises four islands 3. Via connecting bridges 4, island 3 is in the embodiment shown here connected at four locations with another part of the second layer 5 (FIG. 3), which other part is a bulk part. Island 3 functions as mechanically strengthening part and, in accordance with the invention, the connecting bridges 4 provide an exceptionally strong construction.

In the embodiment shown here, the connecting bridges 4, 4′ of adjacent islands 3, placed as far apart as possible. The islands 3 of the device 1 are also provided with resistive heating elements 6, made from doped polycrystalline silicon. When electricity is conducted through a heating element 6, the island 3 is heated, while thanks to the grooves 2, there is little heat dissipation.

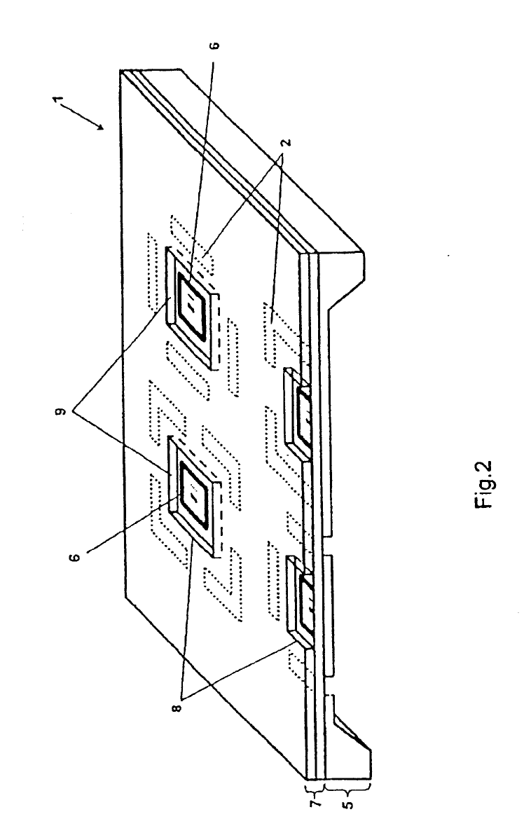

FIG. 2 shows the device of FIG. 1 in a perspective top view. A first layer 7 can be seen, wherein layer 7 comprises the resistive heating elements and the second layer 5. The device has four wells 8, which are bounded by the vertical wall 9, which in this case is part of the first layer 7.

FIG. 3 shows the device of FIG. 1 in a perspective bottom view. The first layer 7 can be seen and the second layer 5, which has grooves 2. Connecting bridges 4 connect island 3 with that part of the second layer 5 that is located outside the islands 3, to provide mechanical strength. This strength is important for handling the device, but also for being resistant to stresses within the device ensuing from heating the island 3.

In the embodiment shown, the depth of the grooves 2 is such that there no material of the second layer 5 is present, but this is not obligatory. The depth of the grooves is preferably at least 50% of the thickness of the second layer 5, more preferably as least 80%, such as 100%.

The embodiment described above is suitable for carrying out the Polymerase Chain Reaction (PRC), a biochemical nucleotide amplification technique wherein the reaction temperature needs to be varied cyclically. In order to real-time monitor the reaction, each island in the above described embodiment is provided with a light-sensitive area 10, and with a temperature sensor 11 for measuring the temperature reached by the heating element 6. Below, the steps for fabricating the described device will be explained.

PCR Chip Fabrication Standard Fabrication Steps

The manufacturing process for manufacturing Polymerase Chain Reaction (PCR) chips is based on a standard 1.6 μm conventional polysilicon gate Complementary Metal Oxide Semiconductor (CMOS) process, based on local oxidation of the silicon (LOCOS). The structure is formed on a 525 μm-thick p-type substrate having an epitaxially growth layer of 12 μm at the front side. The first step in the manufacturing process is the formation at the front side of the wafer of the actuators (heating elements 6, sensors (10 and 11 for measuring the temperature and for optical detection) and read out and control electronics. This step in itself encompasses several manufacturing steps that are standard in the semiconductor manufacturing technology.

The photodetectors 10 are comprised of two stacked p-n junctions. The bottom junction is formed by the pepilayer and the n-well. The top junction is formed by the n-well and a smooth implanted p-layer, which is normally used for drain contacts and source contacts. The resistive heating elements 6 are fabricated from phosphor-doped polycrystalline silicon. The temperature sensor 11 is formed by a lateral PNP transistor in the CMOS process, the lateral transistor is constructed from an implanted p-layer, the n-well and the pepilayer. In order to insulate and protect the structures that are formed, an 800 nm layer of silicon nitride is applied with the aid of a Plasma Enhanced Chemical Vapor Depositor (PECVD).

Special Post-Fabrication Steps

After the above standard CMOS fabrication steps, a number of non-standard post-fabrication steps are applied. For the lithographic steps in this post-fabrication only three masks are used. These masks are used for the (optional) formation of the wells in SU-8 photo resist lacquer 9, for etching the membrane and for forming of the insulation grooves 2. As first step in the post-fabrication a 1 to 2 μm thick layer of silicon nitride is applied to the rear side of the wafer. By means of lithography and etching steps a pattern is provided in the SiN layer, such that by employing a potassium hydroxide (KOH) etching step, the silicon bulk layer can be etched down to a membrane having a thickness of approximately 150 μm. Subsequently, the remainder of the SiN layer on the rear side of the wafer is removed by employing an etching step. On the front side of the wafer an (optional) layer of SU-8 photo resist lacquer is applied. This layer is lithographically provided with a pattern that corresponds with the wells to be formed on the front side and the openings for the electrical connections. After developing the photo resist lacquer the desired wells and openings for realizing the electrical connections are formed in the SU-8 photo resist lacquer. The rear side is now provided with a 2 μm thick layer of silicon oxide. This layer is lithographically provided with a pattern that corresponds with the grooves 2 to be etched. As the last step, the grooves for temperature insulation are formed at the rear side by carrying out a Reactive Ion Etch step (RIE), which stops on the silicon oxide.

The wafer thus formed is then sawn so that the chips can be used individually.

Experiments

The chip fabricated as described above, is mounted on a carrier. The chip is attached to the carrier by means of a glued joint. Care needs to be taken that the glue does not spoil the thermal insulation structure. The purpose of this carrier is to allow the chip to be handled more easily, to create the electrical connections and to protect the chip.

The chip may be provided with control and regulating electronics. If this is the case, communication between the chip and the external world will take place via the control on the chip. The description following below, departs from the chip in its most simple form, this means without control or regulating electronics, only the polysilicon heat resistor and a membrane-integrated diode for temperature measurement are used.

In this experimental set-up an external power source is used to control the heat resistor. The advantage of a power source is that, for example, in the event of the substrate coming through, the power supply is limited whereas this is not the case when using a voltage source. When the chip is in practical use outside the test phase, both a power source and a voltage source can be used.

The membrane temperature is measured by means of the diode implemented on the membrane. This diode's temperature coefficient of the forward voltage is approximately-2.1 mV/° C. In order to measure this forward voltage, a constant current generated by means of a power source is conducted through the diode. With the aid of a preferably digital volt meter the forward voltage of the diode is measured. Prior to measuring, an accurate determination of the diode's temperature dependence may be carried out so as to allow the temperature to be measured accurately. For this purpose the chip with the diode is placed into a climatic cabinet. The temperature in the climatic cabinet is raised through a number of steps, during each temperature step the temperature in the climatic cabinet is kept constant for a sufficiently long time to allow the temperature of the diode in the climatic cabinet to stabilize. At this temperature the forward voltage of the diode is measured. The thus obtained temperature characteristic may be used when measuring the final temperature in the PCR cycle.

For carrying out a PCR cycle a programmable direct current source is used. This source is programmed to progress through the following temperature steps:

1^{st} step: 94° C.

2^{nd} step: 55° C.

3^{rd} step: 72° C.

4^{th} step and subsequent steps (approximately 30×): repeat step 1 to 3

last step: cooling to ambient temperature

The fact that the desired temperature has been reached is registered by means of the integrated diode. When the desired temperature is reached, the power source is adjusted to the power needed to reach the temperature of the subsequent temperature step.

In order to automize this process, it is possible to use a computer that is connected with a digital multi-meter for measuring the forward voltage of the diode, and a programmable power source, for controlling the heat resistance. The computer is provided with control software, for example, VEE from Agilent, and is connected with the measuring apparatus via a communication bus. The computer is programmed such that the PCR cycle is completed (sufficiently quickly).

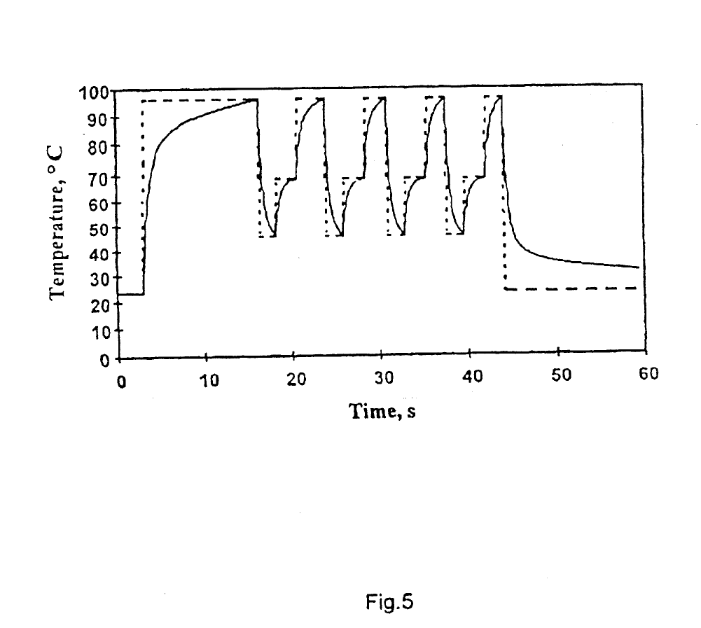

In this test the well is filled with an aqueous test liquid. The well is then sealed at the top side in order to prevent evaporation of the test liquid. With this system it is possible to realize a complete PCR cycle with a running time of approximately three and a half minutes. By way of illustration, FIG. 5 shows how quickly a well can be brought to the desired temperature. The dotted line corresponds to the ideal temperature curve. The dotted line also corresponds to the power conducted through the heating element 6. It goes without saying that by initially sending a stronger current through the heating element 6, the ideal temperature curve can be approached more easily. The creation of hot spots and the accompanying risk of, for example, inactivating an enzyme in the reaction, should be avoided.

Further integration makes it possible for control and regulating electronics carrying out the above described tasks automatically, to be integrated on the chip. The system response can be further improved by using a proportionally integrating differentiating control system.

The present invention also considers the possibility of, in addition to or instead of the recess in the bottom second layer, providing a recess for thermal insulation in the top first layer.

What is claimed is:

1. A device for carrying out a reaction, which device comprises a wafer provided with a group of at least two wells, characterized in that the wells are thermally separate from each other and the device further comprises means for altering the temperature of the wells, wherein:
the wafer comprises at least two layers of which a first, top layer forms the bottom of a well, and the thermal separation is provided by at least one recess in a second layer located under the first layer, such that:
there is at least one recess between two adjacent wells;
the second layer, when projected on the first layer, will at the bottom of a well cover at least part of the bottom, which portion of the second layer that, when projected, covers at least part of the bottom, termed the mechanically strengthening portion;
the second layer is connected by means of at least one bridge with a portion of the second layer located outside of the projected portion of the bottom of the well on the second layer, which projected portion of the second layer is located outside the bottom, termed the bulk portion; and
the means for altering the temperature of the wells are, when projected on the first layer, located at the bottom of a well.

2. A device according to claim 1 characterized in that the recess is formed like a groove.

3. A device according to claim 1 characterized in that the mechanically strengthening portion located under a well is connected with the bulk portion via at least three bridges distributed over the circumference of the mechanically strengthening portion.

4. A device according to claim 1 characterized in that the means for altering the temperature of the wells is integrated in the second layer.

5. A device according to claim 4 characterized in that the means for altering the temperature comprise means for heating the well.

6. A device according to claim 1 characterized in that at least the first layer is an optically transparent layer.

7. A method of manufacturing the device of claim 1, characterized in that:
a wafer, which will form a second layer, is provided with a first, top layer; and
at the bottom side in the second layer, the wafer is provided with a recess between two adjacent wells in the first layer.

8. A method of carrying out a polynucleotide amplification comprising employing a device according to claim 1 and varying the temperature cyclically.
